(19) United States
(12) Patent Application Publication
(10) Pub. No.: US 2009/0105901 A1
(43) Pub. Date: Apr. 23, 2009

(54) System for utilizing vehicle data and method of utilizing vehicle data

(76) Inventors: Mark Haller, Canton, MI (US); Douglas J. Priemer, Harrison Township, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/990,891

(22) PCT Filed: Aug. 22, 2006
(86) PCT No.: PCT/US06/32979

§ 371 Date: Feb. 22, 2008

Related U.S. Application Data
(60) Provisional application No. 60/710,601, filed on Aug. 23, 2005.

(51) Int. Cl. G06F 19/00

(52) U.S. Cl. 701/33

(57) ABSTRACT

A system for monitoring vehicle operating data and transmitting same to a central processing center. The central processing center analyzes the received data and transmits the analyzed data to other vehicles.

### BACKGROUND OF THE INVENTION

1. Field of the Invention

This invention relates in general to vehicle electronic control systems, and in particular to a transmitting and receiving system for sharing vehicle operating data with other vehicles.

2. Description of Related Art

An increasing variety of electronic control systems are being included in motor vehicles. Such systems include, among others, Supplemental Restraint Systems (SRS), Antilock Braking Systems (ABS), Traction Control Systems (TCS), Global Positioning Systems (GPS), Environmental monitoring and control Systems, Engine Control Systems and many others not specifically mentioned here. Communication systems are also becoming ever more common in vehicles. Such systems include, among others, cellular, Personal Communications System (PCS), and satellite based communication systems.

It is known to send information concerning vehicle system activity with a communication system. For example, upon airbag deployment, i.e. activation of an SRS, a notification may be sent via a satellite communications system to a help center, which may then dispatch emergency responders to the site of the airbag deployment. Similarly, it is also known to send data to a vehicle electronic system using a communication system. For example, the GPS satellites may send signals to a vehicle, which may would determine the position of the vehicle and display the position to the vehicle operator.

### BRIEF SUMMARY OF THE INVENTION

This invention relates to a transmitting and receiving system for sharing vehicle operating data with other vehicles.

The system for utilizing vehicle data includes a vehicle monitoring device operable to monitor a parameter of a vehicle that is connected to a vehicle data processor that is operable to transform the monitored parameter into status data. The system also includes a vehicle transmitter connected to the vehicle data processor that is operable to transmit the vehicle status data. The system further includes a central receiver that is connected to a central data processor. The central receiver is operable to receive the vehicle status data transmitted from the vehicle transmitter while the central data processor is operable to generate update data based at least in part upon the vehicle status data received. The system also includes a central transmitter that is connected to the central data processor and is operable to transmit the update data. The system further includes a vehicle receiver that is adapted to be mounted in a vehicle and is operable to receive the update data from the central transmitter and a vehicle update device connected to the second receiver that is operable to update a vehicle system based at least in part upon the update data.

The method of utilizing vehicle data includes the steps of providing the system described above, monitoring a parameter of a vehicle with the vehicle monitoring device; transforming the parameter into vehicle status data with the vehicle data processor and transmitting the status data with the vehicle transmitter. The method also includes receiving the status data with the central receiver; generating update data based at least in part upon the status data with the central data processor and transmitting the update data by broadcasting with the central transmitter. The method further includes receiving the update data with the vehicle receiver and updating a vehicle system based at least in part upon the update data with the vehicle update device.

Various objects and advantages of this invention will become apparent to those skilled in the art from the following detailed description of the preferred embodiment, when read in light of the accompanying drawings.

### BRIEF DESCRIPTION OF THE SEVERAL VIEWS OF THE DRAWINGS

FIG. 1 is a schematic diagram of a system for utilizing vehicle data in accordance with the present invention.

FIG. 2a is a vehicle portion of a flow chart for the operation of the system shown in FIG. 1.

FIG. 2b is a data center portion of a flow chart for the operation of the system shown in FIG. 1.

FIG. 3 is a flow chart for a subroutine contained in block 126 of FIG. 2a.

### DETAILED DESCRIPTION OF THE INVENTION

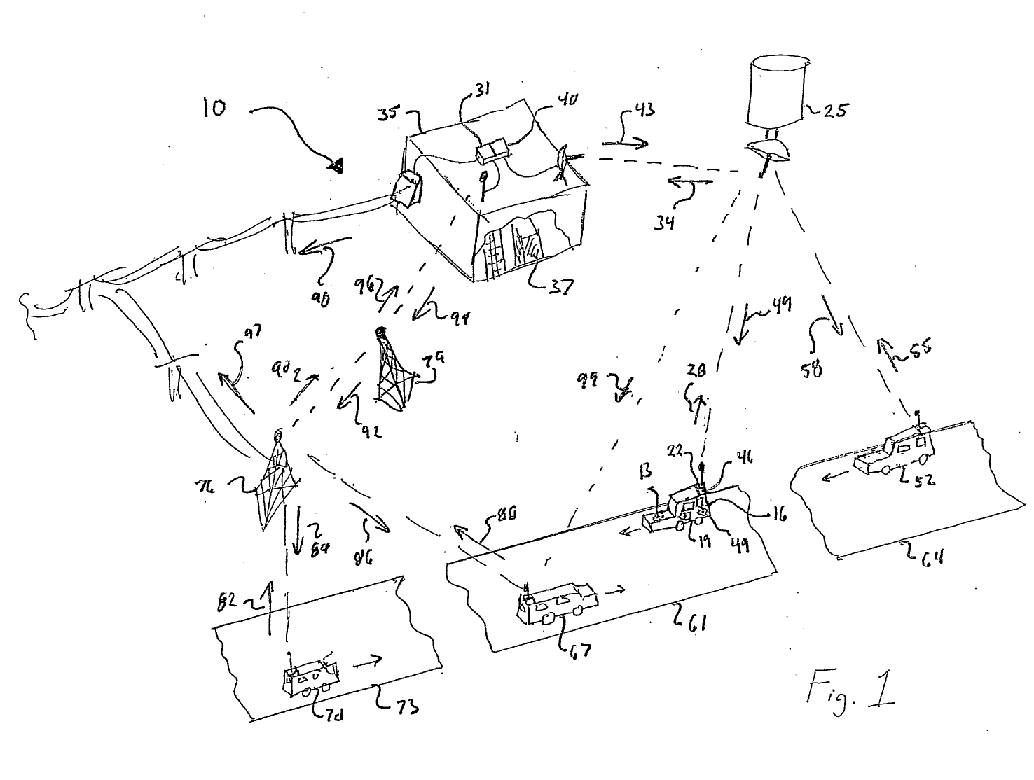

Referring now to the drawings, there is illustrated in FIG. 1 a system for transmitting and receiving vehicle data in accordance with the present invention, indicated generally at 10.

The system 10 includes a monitoring device 13 that is mounted within a first vehicle 16 and operable to monitor an operating parameter of the vehicle 16. The monitoring device 13 may be placed in any suitable location. In the preferred embodiment, the monitoring device 13 is a sensor, such as a speedometer, accelerometer, temperature sensor, or any other suitable sensor. Alternately, the monitoring device 13 may be a microprocessor, Application Specific Integrated Circuit (ASIC), or other electronic device for monitoring the operations of one of the vehicle systems, such as, for example, ABS, TC, or VSC systems.

The system 10 also includes a vehicle data processor 19. Preferably, the vehicle data processor 19 is a conventional device for transforming data, such as a microprocessor, integrated circuit, ASIC, or any other suitable device. The processor 19 is in communication with the monitoring device 13 in a conventional manner, such as with wireless networking, RF transmission, hard wiring, or any other suitable manner. The data processor 19, which may be mounted in any suitable location upon the vehicle and is operable to transform the parameter monitored by the vehicle monitoring device 13 into vehicle status data in a desired format.

The system 10 further includes a vehicle transmitter 22 connected to the vehicle data processor 19. The vehicle transmitter 19 is operable to transmit the formatted vehicle status data to a communications relay link or a central receiver. The vehicle transmitter 19 is shown in FIG. 1 as transmitting the vehicle status data to a satellite 25, as indicated by the broken line and arrow labeled 28; however, the invention also may be practiced with the vehicle transmitter 22 transmitting data to an antenna or other receiving structure.

While the vehicle monitoring device, data processor and transmitter 13, 19 and 22 have been shown in FIG. 1 as separate components, it must be understood that all or some of the individual components may be integrated into a single unit. Additionally, the invention contemplates that the vehicle data processor 19 also may be receiving data from a plurality of sensors and/or vehicle systems (not shown). All of the received vehicle information would be formatted and transmitted.

As shown in FIG. 1, the satellite 25 is a repeater that relays the signal from the vehicle transmitter 22 to a central receiver 31, as indicated by the broken line and arrow labeled 34. It must be understood that the repeater may be any suitable repeater, and, as indicated above, the invention also contemplates a system without a repeater at all where the vehicle transmitter 22 and the central receiver 31 are in direct communication.

As shown in FIG. 1, the central receiver 31 is located at a central data center 35 that is remotely located, i.e., at a separate location, from the vehicle transmitter 22. The central receiver 31 is operable to receive the vehicle status data transmitted from the vehicle 19. A central data processor 37 is connected to the central receiver 31. The central data processor 37 is operable to generate update data based at least in part upon the received vehicle status data. In the preferred embodiment, the processor 37 is a computer (not shown) that includes an algorithm for analyzing the vehicle status data. The computer is operable to generate update data based at least in part upon the algorithm analysis. It must be understood, however, that the central data processor 37 may be any suitable device. The processor 37 also includes a memory (not shown) for storing the vehicle status data. In the preferred embodiment, the central data processor also receives vehicle data from other vehicles. Optionally, the analyzing device 37 may receive information from a non-vehicle source, such as for example, a weather forecasting service. Thus, when the vehicle status data is analyzed, the central processor 37 may combine the status data with information received from other vehicles and non-vehicle sources that is stored in the memory. The central processor 37 is connected to a central transmitter 40 that is operable to transmit the update data. While the central receiver, processor, and transmitter 31, 37, and 40 are shown as being located together at the data center 35, it must be understood that the invention also may be practiced with components located separately.

The central transmitter 40 is shown in FIG. 1 as transmitting the update data to the satellite 25 as indicated by the broken line and arrow labeled 43. The satellite 25 is acting to relay the update data to a vehicle receiver 46, as indicated by the broken line and arrow labeled 49. The vehicle receiver 46 is adapted to be mounted upon the first vehicle 16, and thus is located remotely from the central transmitter 40. The vehicle receiver 46 is operable to receive the update data from the central transmitter 40. It must be understood that the central transmitter 40 and the vehicle receiver 46 may be in communication through a repeater or in direct communication with one another. The vehicle receiver 46 is connected to a vehicle update device 49. The vehicle update device 49 is operable to update a vehicle system based at least in part upon the update data received, as will be further explained below.

It is contemplated that the system 10 further includes a second vehicle 52. The second vehicle 52 also includes one or more vehicle monitoring devices (not shown) and processing, transmitting and receiving components as described above. Thus, the second vehicle 52 is able to send vehicle status data to the central data center 35 and receive update data, as indicated at 55 and 58.

The operation of the system 10 will now be described. While the first vehicle 16 is traveling on a section of road 61, the vehicle 16 may encounter an event, such as black ice, and a vehicle system may be activated, such as TCS. The vehicle 16 will then report the event and location to the data center 35 as vehicle status data. The location may be determined by a GPS system (not shown) using satellite communication, such as with the satellite 25, or with other satellites (not shown).

Upon receiving the vehicle status data the central data processor 37 will determine whether the section of road 61 has a hazard, such as black ice. If such a determination is made, the data center 35 will report the condition to other vehicles heading into road section 61, such as the second vehicle 52 that is currently on a road section 64, a third vehicle 67 on a road section 61, and a fourth vehicle 70 on a road section 73. The report would be included in the transmission of update data as described above. The vehicle update devices within the vehicles receiving the update data would then update systems within the vehicles. For example, the TCS in the third vehicle 61 in road section 67 may be sensitized to the conditions by changing parameters within the system and/or the navigation system in the second vehicle 52 may be updated to divert the driver of the vehicle away from the event.

As shown in FIG. 1, the third and fourth vehicles 67 and 70 are in continuous communication with the data center 35 via Cellular and PCS towers 76 and 79, respectively, as indicated by the arrows 82, 84, 86, 88, 90, 92, 94, and 96. As also shown in FIG. 1, some of the communication is transferred across hard wired systems, such as by telephone lines as indicated at 97 and 98. Further, the location of the fourth vehicle 70 may be determined by the GPS functionality of the cellular or PCS towers, and the location of the third vehicle 67 may be determined by the GPS functionality of the cellular or PCS towers, or the GPS satellite system, as indicated by the arrow 99. Thus the third and fourth vehicles 67 and 70 may have cellular or PCS transceivers and not necessarily need satellite transceivers.

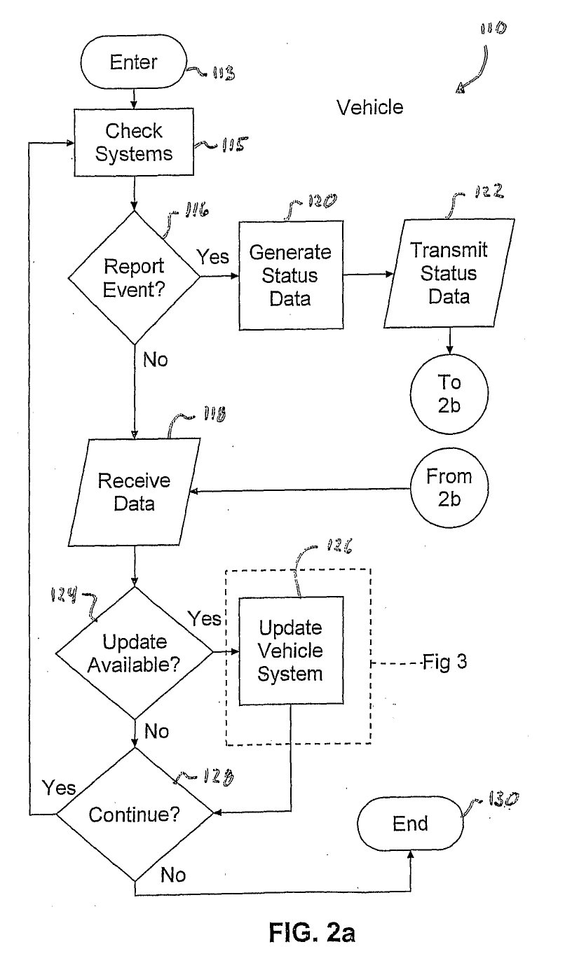

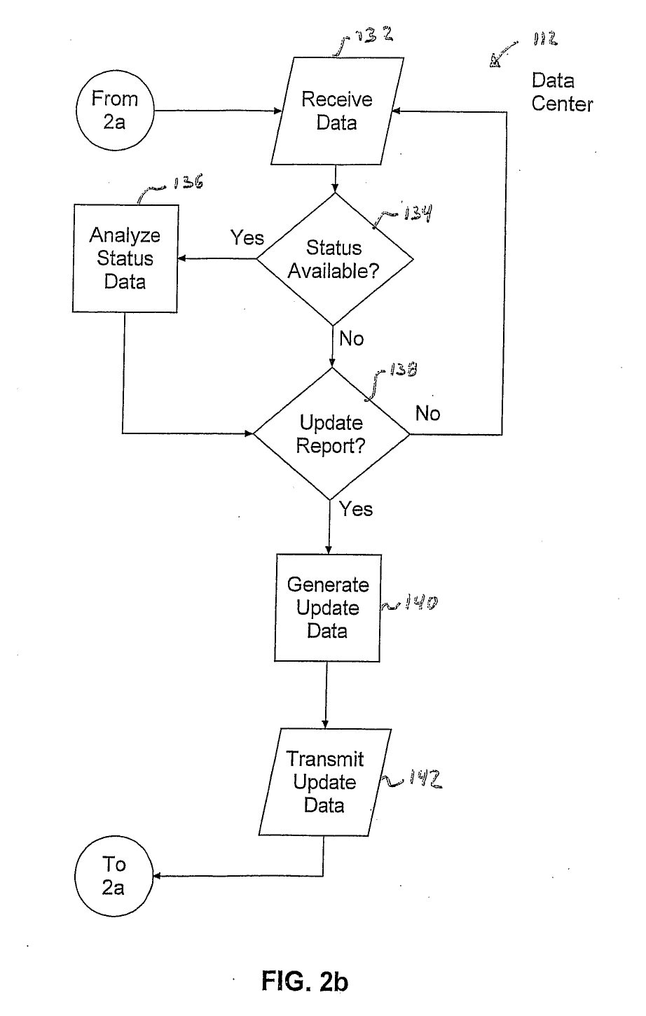

There is shown in FIGS. 2a and 2b, a flow chart for an algorithm for utilizing vehicle data in accordance with the present invention. A first portion 110 of the algorithm that is utilized within the vehicle 19 is shown in FIG. 2a while a second portion 112 of the algorithm that is utilized within the data center is shown in FIG. 2b. While the vehicle portion 110 is illustrated for use within a single vehicle, it must be understood that the vehicle portion 110 may be practiced within many vehicles, such as the vehicles 16, 52, 67, and 70 of the system 10 shown in FIG. 1. Also, while the algorithm is suitable for use with the system of FIG. 1, but it must be understood, that the algorithm may be used with any suitable system. The steps the vehicle portion 110 may be performed by any suitable module, component, or apparatus within a vehicle. Similarly, the steps within the data center portion 112 may be performed by any suitable module, component, or apparatus within the data center 35. It must be understood, however, that performance of these steps may be carried out in any suitable manner, by any suitable device, in any suitable location.

The vehicle portion 110 of the algorithm is entered through block 113 and begins in functional block 115 where a system or state of a vehicle is checked, i.e., a parameter is monitored, by the monitoring device 13 of the system 10 mounted within the vehicle 16. The vehicle portion 110 proceeds to decision block 116 where it is determined if a reportable event has occurred, such as the activation of a previously inactive system, or if a sensed vehicle parameter, such as temperature, has crossed a predetermined threshold. If a reportable event has not occurred, the vehicle algorithm portion 110 transfers to functional block 118. However, if it is determined in decision block 116 that a reportable event has occurred, the algorithm portion 110 transfers to functional block 120.

In functional block 120, the monitored parameter is transformed into vehicle status data. The vehicle status data may be generated by the data processor 19 of the system 10, or by any device suitable to transform the monitored vehicle parameter into status data. The vehicle algorithm portion 110 then proceeds to functional block 122 where the vehicle status data is transmitted to the data center 35. In the preferred embodiment, the vehicle status data is transmitted by the vehicle transmitter 22; however, any device operable to transmit the data also may be utilized. The operation of the algorithm in the data center is illustrated in FIG. 2b and described below. After the data is processed in the data center, the algorithm returns to functional block 118 in FIG. 2a.

In functional block 118, the update data is simultaneously received by the receivers mounted within all of the vehicles, 19, 52, 67, and 70. The vehicle algorithm portion 110 then continues to decision block 124, where it is determined if update data has been received. If update data is available, then the algorithm portion transfers to functional block 126 where a vehicle system is updated, if appropriate, in each of the vehicles receiving the data with the system update based at least in part upon the update data received. Additionally, the invention contemplates that a plurality of systems within the vehicles, 16, 52, 67, and 70 may be updated by their respective vehicle update device. The vehicle algorithm portion 110 then proceeds to decision block 128. If, in decision block 124, it is determined that an update is not available, the algorithm portion transfers directly to decision block 128.

In decision block 128, it is determined if the algorithm is to continue. If the algorithm is to continue, the algorithm returns to functional block 115 and continues as described above. If the algorithm is not to continue, the algorithm exits through block 130.

Referring now to FIG. 2b, the data center portion 112 of the algorithm is entered through functional block 132 where vehicle status data is received by the central receiver 31 at the data center 35, or by any other device operable to receive the status data. While the data center portion 112 is illustrated for use within a single facility, however it must be understood that the data center portion 112 also may be practiced at separate facilities. The data center portion 112 continues to decision block 116 where it is determined if status data has been received. If status data has been received, then the data center portion 112 transfers to functional block 136 where the status data is analyzed with an algorithm within the central data processor 37. The processor 37 also may utilize data received from other vehicles and/or non-vehicle generated data in the analysis. The data center algorithm portion 114 then proceeds to decision block 138. If, in decision block 134, it is determined that statues data has not been received, then the data center algorithm transfers directly to decision block 138.

In decision block 138 it is determined if an update report is to be generated. If an update report is to be generated then the data center algorithm portion 112, transfers to functional block 140 where update data is generated, based upon the data analysis performed in functional block 136. The data center portion then continues to functional block 142 where the update data is transmitted by broadcasting and the algorithm returns to functional block 118 in FIG. 2a. If, however, in decision block 138, it is determined that an update report is not to be generated, then the data center portion 112 transfers back to functional block 132 to receive more vehicle status data.

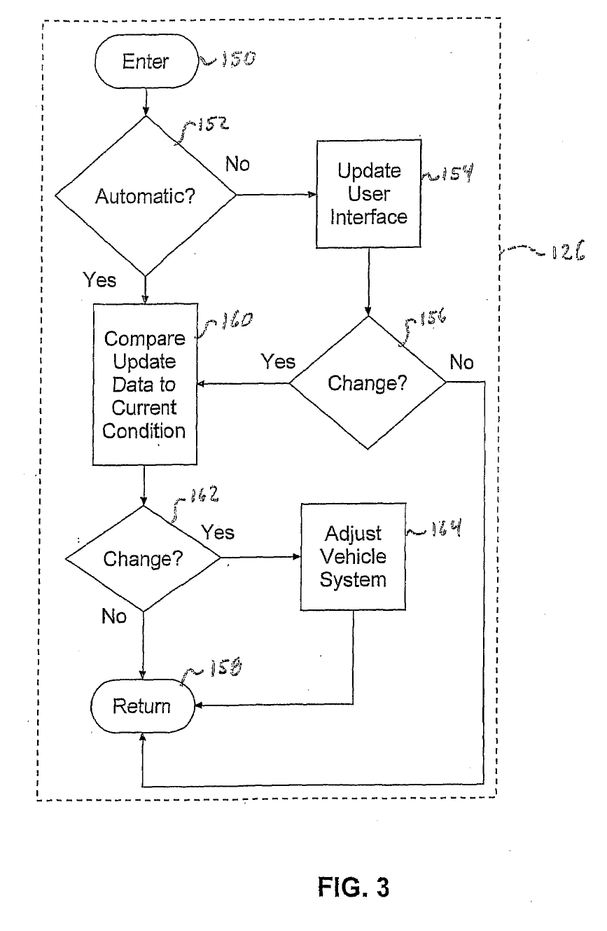

There is illustrated in FIG. 3 a detailed subroutine that is utilized within functional block 126 of the vehicle portion 110 of the algorithm. The subroutine is entered through block 150 and proceeds to decision block 152 where it is determined if a vehicle system is to be automatically updated. If the vehicle system is not to be updated automatically, then the subroutine transfers to functional block 154 where a user interface is updated. Such a user interface may be, for example, an alert display, upon which are shown an update based upon received data. The subroutine then proceeds to decision block 156 where it is determined if the vehicle operator is going to initiate a change, for example based upon the updated user interface. If it is determined, in decision block 156, that the vehicle operator is not going to initiate a change, then the subroutine returns through block 158 to decision block 128 in the vehicle portion 110 shown in FIG. 2a. If, however, in decision block 156, it is determined that the vehicle operator is to initiate a change then the subroutine transfers to functional block 160. Similarly, if in decision block 152, it is determined that the vehicle system is to be automatically updated, the subroutine transfers directly to functional block 160.

In functional block 160 the update data received is compared to the current condition of the vehicle. The subroutine then proceeds to decision block 162 where it is determined if the state of a vehicle system is to be changed, that is, parameter values within the system modified. If the state of a vehicle system is to be changed, then the subroutine transfers to functional block 164 where the system or parameter is adjusted. The subroutine returns through block 158 to decision block 128 in the vehicle portion 110 shown in FIG. 2a. Returning to decision block 162, if it is determined that a system is not to be changed then the subroutine returns directly through block 158 to decision block 128 in the vehicle portion 110 shown in FIG. 2a.

It will be understood, however, that a vehicle system may thus be updated by the use of update data regardless of whether or not a change in the state of the system has occurred.

While the preferred embodiment has been illustrated by the flow charts shown in FIGS. 2a, 2b and 3, it will be appreciated that the flow charts are exemplary and that the invention also may be practiced with algorithms other than those shown in the figures.

In one embodiment of the present invention when there is an activation or deactivation of a system, e.g., ABS, TCS, VSC, etc., in a traveling vehicle, the system 10 may determine that an accident preventative measure should be taken by other vehicles in the area relating to specific road conditions. The specific measure to be taken would be determined by the change of the specific vehicle system. For example, data may be generated that indicates that ABS has been activated while the vehicle is traveling at a high speed or TCS has been activated under light/medium acceleration or deceleration. This data may be combined with knowledge of temperature, rain (precipitation), activation of wiper systems, etc. . . . , by the system 10 to determine that the present portion of road potentially contains hazards, such as black ice, slush, or other hazards. In response to the determination, the system may sensitize the appropriate safety systems of other vehicles in the general area, or traveling along a specific section of road, by modifying the system parameters in accordance with the detected road conditions. In extreme cases, for example, if there are stopped vehicles ahead, a warning could be presented to the vehicle operator while the vehicle is slowed and the emergency flashers activated.

Additionally, instead of and/or in addition to automatic activation, the data and/or information may be used to sensitize, i.e. change the activation/deactivation thresholds of, the safety systems in a vehicle. Alternately, the data may prompt a warning to the driver, e.g., through a user interface, notify automatic cruise control systems to extend the inter-vehicle distances, warn integrated weather services, or similar functions and/or actions . . . .

Furthermore, while the present invention has been described as a system using single pieces of data/information, e.g., from a single monitored parameter, the system 10 also is intended to integrate clusters of data/information, e.g. from multiple monitored parameters, such as the state change of multiple vehicle systems, such as ABS, SCS, SRS, and such. Additionally, as described above, it also must be understood that the system 10 may integrate such multiple data from a single vehicle or from multiple vehicles, for example, to indicate significant traffic events such as multi car incidents and data received from non-vehicle sources. The system can thus be used to provide robust warnings to drivers. Specifically, one vehicle system which may be updated is a vehicle navigation system. The navigation system may be automatically set to divert traffic around accidents or possible accidents.

In another embodiment, the system 10 may be set such that a vehicle may send an ABS active message when there is precipitation or the temperature is below 32 F. This may be transmitted while other information may be suppressed to minimize the load on the receiving system. Further, the system 10 may request information from vehicles in the system to supply more information from a single vehicle, thus adding more detail, or to supply more information from multiple vehicles, thus adding more coverage or area or road. Thus, the system may notify network vehicles in the vicinity (or elsewhere) to send more information of a specific nature of vehicle control, such as the specific actions of the Enhanced Stability Controls, ESC.

The present invention also contemplates another embodiment where a system includes a report function for users to input information, such as witnessing of an accident, or spotting of dangerous road conditions. Such a system may include the capability to indicate that the user's vehicle was ‘not involved’. The “not involved” warning system may be implemented, for example, when the spin out of another vehicle is seen, when a possible recent accident is seen (on or off the road), or when any vehicle is seen to be stopped or any condition may be reported for safety, or any other, reasons.

For example, the passing driver i.e., the user in the “not involved” vehicle, may push a “not involved” button which can report the event and/or correlate the event by the system to update other vehicles or to notify emergency responders, such police patrols, or fire rescue. In addition this reporting may be used to advise oncoming drivers of possible obstacles in the road.

Further, it must be understood that information/data concerning operation of vehicle systems, such as activation of ABS, TCS, VSC, and such may be collected via telemetry at one or more central locations and then transmitted to other vehicles in the same geographical area, or in other areas, to warn of potential hazardous driving conditions. Thus, the other vehicles may update vehicle systems, such as notification, safety, and performance systems.

While the principle and mode of operation of this invention have been explained and illustrated with regard to particular embodiments, it must be understood, however, that this invention may be practiced otherwise than as specifically explained and illustrated without departing from its spirit or scope. Thus, for example, the invention also contemplates use of a transceiver in the vehicles in place of the separately described vehicle transmitter and receiver.

1. A system for utilizing vehicle data comprising:
a vehicle monitoring device operable to monitor a parameter of a vehicle;
a vehicle data processor connected to said vehicle monitoring device, said vehicle data processor operable to transform said monitored parameter into vehicle status data;
a vehicle transmitter adapted to mounted upon a vehicle and connected to said vehicle data processor, said vehicle transmitter operable to transmit said vehicle status data;
a central receiver operable to receive said vehicle status data transmitted from said vehicle transmitter;
a central data processor connected to said central receiver, said central data processor operable to analyze said vehicle status data and to generate update data based at least in part upon said received vehicle status data;
a central transmitter connected to said central data processor, said central transmitter operable to transmit said update data;
a vehicle receiver adapted to be mounted upon a vehicle, said vehicle receiver operable to receive said update data from said central transmitter; and
a vehicle update device connected to said vehicle receiver, said vehicle update device operable to update at least one vehicle system based at least in part upon said update data.

2. The system of claim 1 wherein said central data processor includes a computer.

3. The system of claim 2 wherein said central data processor computer includes an algorithm for analyzing said status data and further wherein said update data based at least in part upon said algorithm analysis.

4. The system of claim 1 wherein said vehicle transmitter and said vehicle receiver are mounted upon the same vehicle.

5. The system of claim 1 wherein said vehicle transmitter and said vehicle receiver are mounted upon different vehicles.

6. The system of claim 1 wherein said vehicle receiver is a first vehicle receiver that is adapted to mounted upon a first vehicle and further wherein the system includes a second vehicle receiver that is adapted to mounted upon a second vehicle, said second vehicle receiver also operable to receive said update data.

7. The system of claim 6 wherein said vehicle transmitter is a first vehicle transmitter that is to adapted to be mounted upon said first vehicle and further wherein the system includes a second vehicle transmitter adapted to mounted upon said second vehicle, said second transmitter operable to transmit vehicle status data from said second vehicle to said central receiver.

8. The system of claim 8 wherein said central data processor is operable to analyze said vehicle status data received from both said first and second vehicles and to generate update data based at least in part upon said vehicle status data received from both said first and second vehicles.

9. A method of utilizing vehicle data comprising the steps of:
(a) providing a vehicle monitoring device operable to monitor a parameter of a vehicle, the vehicle monitoring system including:
(a1) a vehicle data processor operable to transform the monitored parameter into vehicle status data:
(a2) a vehicle transmitter operable to transmit the vehicle status data:
(a3) a central receiver operable to receive the status data:
(a4) a central data processor operable to analyze the vehicle status data and to generate update data based at least in part upon the status data:
(a5) a central transmitter operable to transmit the update data, a vehicle receiver operable to receive the update data: and
(a6) a vehicle update device operable to update a vehicle system based at least in part upon the update data;
(b) monitoring a parameter of a vehicle with the vehicle monitoring device;
(c) transforming the parameter into vehicle status data with the vehicle data processor;
(d) transmitting the vehicle status data with the vehicle transmitter;
(e) receiving the vehicle status data with the central receiver;
(f) generating update data with the central data processor, the update data based at least in part upon the vehicle status data with the central data processor;
(g) transmitting the update data with the central transmitter;
(h) receiving the update data with the vehicle receiver; and
(i) updating a vehicle system based at least in part upon the update data with the vehicle update device.

10. The method of claim 9 wherein the central data processor provided in step (a4) includes a computer and an algorithm that is utilized by the central data processor for analyzing the status data and step (f) includes analyzing the status data with the algorithm and further wherein the update data is based at least in part upon the algorithm analysis of the vehicle status data.

11. The system of claim 8 wherein the system includes a plurality of vehicles, with each vehicle equipped with a vehicle transmitter and vehicle receiver, each of said vehicles being capable of transmitting vehicle parameter data to said central data processor and receiving update data from said central data processor, said update data being based at least in part upon said vehicle parameter data.

12. The system of claim 11 wherein said central data processor also receives information from at least one non-vehicle source, said central data processor being operable to combine said non-vehicle source information with said received vehicle parameter data to generate said update data.

13. The system of claim 12 wherein said non-vehicle source provides current weather conditions and further wherein said central data processor combines said current weather conditions with said received vehicle parameter data to determine that hazardous road conditions exist and to transmit said hazardous road condition data to vehicles that are in the vicinity of said hazardous road conditions.

14. The system of claim 13 wherein said vehicle parameter is generated by an electronically controlled brake system.

15. The system of claim 14 wherein said received update data is utilized to modify parameters within said electronically controlled brake system.

16. The system of claim 12 wherein said central data processor is operable to identify a particular section of road where said hazardous road conditions exist and to identify vehicles that are operating in the vicinity of said particular section of road and further wherein said central data processor is also operable to transmit update data relating to said particular section of road to said vehicles that are operating in the vicinity of said particular section of road.

17. The system of claim 16 wherein said central data processor is operable to receive data from a Ground Positioning System and from vehicle navigation systems and further wherein said central data processor is operable to utilize said Ground Positioning System data and said vehicle navigation system data to identify said particular section of road where said hazardous road conditions exist and to identify said vehicles that are operating in the vicinity of said particular section of road.

18. The system of claim 17 wherein said central data processor also receives current weather conditions and further wherein said central data processor combines said current weather conditions with said received vehicle parameter data and said Ground Positioning System data to determine said particular section of road where said hazardous road conditions exist.

19. The method of claim 9 wherein the system provided in step (a) includes a plurality of vehicles, with each vehicle equipped with a vehicle transmitter and vehicle receiver, each of the vehicles being capable of transmitting vehicle parameter data to the central data processor and receiving update data from the central data processor, the update data being based at least in part upon the vehicle parameter data.

20. The method of claim 19 wherein the central data processor also receives information from at least one non-vehicle source, the central data processor being operable to combine the non-vehicle source information with the received vehicle parameter data to generate the update data.
